(19) United States
(12) Patent Application Publication
(10) Pub. No.: US 2023/0229510 A1
(43) Pub. Date: Jul. 20, 2023

(54) RESOURCE SCHEDULING WITH UPGRADE AWARENESS IN VIRTUALIZED ENVIRONMENT

(71) Applicant: VMware, Inc., Palo Alto, CA (US)

(72) Inventors: Matthew Kim, San Jose, CA (US); Maarten Wiggers, Mountain View, CA (US); Charan Singh, Bengaluru (IN)

(21) Appl. No.: 17/579,217

(22) Filed: Jan. 19, 2022

(51) Int. Cl. G06F 9/50; G06F 11/34

(52) U.S. Cl. CPC G06F 9/5038; G06F 9/505; G06F 9/5077; G06F 11/3414; G06F 2209/505

(57) ABSTRACT

Aspects of workload reallocation within a software-defined data center (SDDC) undergoing an upgrade are described. As upgrades become available for services and other types of applications installed on a cluster of host devices within a data center, an upgrade of the installed services may be required for each of the host devices. During a cluster upgrade, the order in which hosts in the cluster are upgraded is determined as a function of evacuation costs and evacuation policies associated with each host device in the computing cluster. In addition, a maintenance cost associated with a workload needing to be evacuated from a host undergoing an upgrade is determined based on the upgrade sequence. The maintenance cost can then be used as a factor for selecting an optimal candidate host for migrating the workload to when the host the workload is currently running on is being upgraded.

### BACKGROUND

Cloud computing systems can extend the capabilities of an organization's data center using computing resources such as virtual machines. A virtualized computing environment can include various host devices that are executing virtual machines that perform various tasks for an enterprise. The virtualized computing environment can support a virtual desktop infrastructure, server infrastructure, user authentication services, security systems, or other computing needs and tasks that might be required by an enterprise. The virtualized computing environment can be managed by a virtualization management system that can manage a virtual infrastructure across a public, private, or hybrid cloud environment. The virtualization management system can also orchestrate containerized execution environments that allow an enterprise to deploy or publish applications for its users.

As the scale, scope, and importance of virtualized computing environments increases, downtime of an environment comes with increasing costs. An enterprise might be resistant to experiencing any downtime of the environment. However, upgrading the virtualized computing environment, and in particular, the host devices, is periodically necessary. Upgrade of the host devices via the virtualization management system can introduce new features, fix bugs and errors, and improve the functioning of the virtualized computing environment, which can in turn improve the ability of administrators to manage a virtualized computing environment.

Typically, before the host can be upgraded, the workload running on a given host may need to be evacuated and reassigned to another host in the data center. However, when deciding the optimal host to receive the evacuated workload, resource schedulers typically assume that the availability of another host in the data cluster will not be changed for a certain amount of time, and thereby fail to acknowledge an upgrade status of the other hosts. Without consideration of the upgrade status for the hosts when making scheduling decisions, there is a possibility that a workload may be inadvertently placed in a host that may require imminent workload evacuation which may result in resource contention issues and further delay in the upgrade process. Therefore, improving resource scheduling by considering an upgrade status can be an important feature.

### BRIEF DESCRIPTION OF THE DRAWINGS

FIG. 1 is an example of a block diagram of a networked environment including a virtualization computing environment according to various examples of the disclosure.

FIG. 2 is a flowchart illustrating how the virtualization management system updates a cluster of hosts according to a predefined upgrade sequence and considers the upgrade status of hosts when determining an optimal host for placement of evacuated virtual machines (VMs) from the host being upgraded according to various embodiments of the disclosure.

FIG. 3 is a flowchart illustrating how the virtualization management system determines an upgrade sequence for upgrading a cluster of hosts according to various embodiments of the disclosure.

FIG. 4 is a flowchart illustrating how the virtualization management system determines a maintenance cost for VMs needing to be migrated from one host to another host based on an upgrade status of the hosts according to various embodiments of the disclosure.

FIG. 5 is a flowchart illustrating how the virtualization management system considers the maintenance costs associated with VMs as a factor for host placement of VMs according to various embodiments of the disclosure.

### DETAILED DESCRIPTION

The present disclosure relates to placement of workloads, such as virtual machines (VMs), within a software-defined data center (SDDC) undergoing an upgrade with consideration of an upgrade status of each the hosts according to various embodiments. As upgrades become available for services and other types of applications installed on a cluster of host devices within a data center, an upgrade of the installed services may be required for each of the host devices. During a cluster upgrade, the order in which hosts in the cluster are upgrade can have an impact on the workloads and other operations running on the hosts. In addition, in various examples, the workloads must be evacuated to other hosts within the data center before a given host can be upgraded. According to various examples, a maintenance cost function representing performance losses for migrating a workload from one host to other hosts in the data center can be determined based on an upgrade sequence associated with the cluster of hosts. This maintenance cost function can be used as a factor for selecting an optimal candidate host for migrating the workload to when the host the workload is currently running on is upgraded. Accordingly, the decision making for the placement of the evacuated workloads considers how the upgrade status of candidate hosts may impact the workloads by considering costs associated with placement of a workload in a host that may require workload evacuation.

A software defined data center (SDDC) infrastructure can include different software-based systems that are used for the overall implementation and operation of a virtualized computing environment for an enterprise. Upgrades can become available for the different types of software services used to create the systems of the virtualized computing environment. In various examples, when an upgrade becomes available, each host in the cluster of hosts of the data center may need to be upgraded. As each host is upgraded, the workload (e.g., VMs or other objects) running on the host may need to be evacuated and placed on another host in the cluster of hosts. One implementation of the virtualized computing environment can include (1) an upgrade manager that can manage the deployment, upgrades, and configuration of the different software-based systems and services and (2) a resource scheduler or management service that can allocate workloads to one or more hosts based on various factors.

According to various examples, the upgrade manager determines an upgrade sequence which defines an order in each the hosts of a computing cluster are to be upgraded to maximize efficiencies of the workloads executing on each of the hosts. The upgrade sequence can be determined as a function of evacuation costs, scheduling constraints for each host in the cluster of hosts requiring the upgrade, and/or other factors. The evacuation cost corresponds to the cost associated with shutting down VMs and other services and objects executing on the hosts and migrating the VMs and other services and objects to another hosts. The evacuation policies are defined by an administrator and correspond to policies for migrating workloads within a computing cluster. In some examples, a customer impact may also be considered in determining the upgrade sequence. For example, if a VM is running a database that migration of could negatively impact the customer, this impact could be a factor in determining the upgrade sequence (e.g., migrate towards the end to limit number of times the VM may need to be migrated). Once the evacuation costs and evacuation policies are determined for each host to be upgraded, the upgrade manager defines an upgrade sequence based on the evacuation costs and evacuation policies. In various examples, the upgrade sequence can be dynamically updated following the upgrade of a given host.

According to various examples, the upgrade sequence can be used to determine the maintenance cost function for a given workload running on a given host. In various example, the maintenance cost function is based on the upgrade sequence, the performance loss of migrating the workload from the host, performance losses of the workload by migrating the workload from the current host to each of the other hosts in the computing cluster, and a migration probability that the workload will require subsequent migrations after being placed on a host due to the host requiring an upgrade. In various examples, the maintenance cost function is used to calculate a maintenance cost efficiency associated with the workload. In various examples, the maintenance cost efficiency is calculated based on the maintenance cost function and the CPU demand required by the workload. In various examples, the resource scheduler considers the maintenance cost efficiency as a factor, in addition to the efficiency values of other resources (e.g., CPU, memory, etc.), in selecting an optimal candidate host for migrating a workload to when the host that the workload is currently running on is placed in a maintenance mode for upgrade.

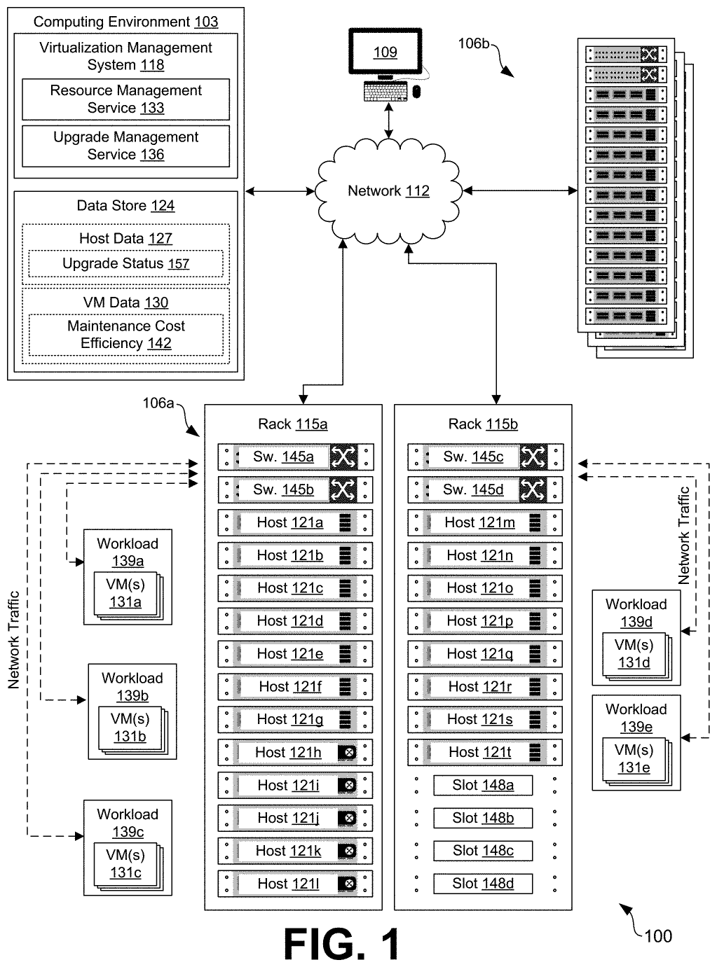

With reference to FIG. 1, an example of a networked environment 100 is shown. The networked environment 100 can include a computing environment 103, various computing clusters 106 (e.g., 106a, 106b), and one or more client devices 109 in communication with one another over a network 112. The network 112 can include wide area networks (WANs) and local area networks (LANs). These networks can include wired or wireless components, or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks. As the networked environment 100 can serve up virtual desktops to end users, the networked environment 100 can also be described as a virtual desktop infrastructure (VDI) environment.

In some examples, the computing environment 103 can include an enterprise computing environment that includes hundreds or even thousands of physical machines, virtual machines, and other software implemented in devices stored in racks 115 (e.g., 115a, 115b), distributed geographically and connected to one another through the network 112. It is understood that any virtual machine or virtual appliance is implemented using at least one physical device.

The computing environment 103 can include, for example, a server or any other system providing computing capability. Alternatively, the computing environment 103 can include one or more computing devices that are arranged, for example, in one or more server banks, computer banks, computing clusters, or other arrangements. The computing environment 103 can include a grid computing resource or any other distributed computing arrangement. The computing devices can be located in a single installation or can be distributed among many different geographical locations. Although shown separately from the computing clusters 106, in some examples, the computing clusters 106 can be a portion of the computing environment 103. Various applications can be executed on the computing environment 103. For example, a virtualization management system 118 can be executed by the computing environment 103. Other applications, services, processes, systems, engines, or functionality not discussed in detail herein may also be executed or implemented by the computing environment 103.

The computing environment 103 can include or be operated as one or more virtualized computer instances. For purposes of convenience, the computing environment 103 is referred to herein in the singular. Even though the computing environment 103 is referred to in the singular, it is understood that a plurality of computing environments 103 can be employed in the various arrangements as described above. As the computing environment 103 communicates with the computing clusters 106 and client devices 109 for end users over the network 112, sometimes remotely, the computing environment 103 can be described as a remote computing environment 103 in some examples. Additionally, in some examples, the computing environment 103 can be implemented in hosts 121 (e.g., 121a . . . 121t) of a rack 115 and can manage operations of the virtualized computing environment 103. Hence, in some examples, the computing environment 103 can be referred to as a management cluster in the computing clusters 106.

The computing environment 103 can include a data store 124. The data store 124 can include memory of the computing environment 103, mass storage resources of the computing environment 103, or any other storage resources on which data can be stored by the computing environment 103. The data store 124 can include memory of the hosts 121 in some examples. In some examples, the data store 124 can include one or more relational databases, object-oriented databases, hierarchical databases, hash tables or similar key-value data stores, as well as other data storage applications or data structures. The data stored in the data store 124, for example, can be associated with the operation of the various services or functional entities described below. For example, host data 127, virtual machine (VM) data 130, and/or other data can be stored in the data store 124.

In various embodiments, the virtualization management system 118 is a computer program that resides and executes in a central server, which may reside in the computing environment 103, or alternatively, can run in a VM 131 (e.g., 131a . . . 131e) in one of hosts 121. One example of a virtualization management module is the vCenter Server® product made available from VMware, Inc. The virtualization management system 118 is configured to carry out administrative tasks for a virtualized environment, including managing hosts 121, managing workloads 139 (e.g., 139a . . . 139f), managing VMs 131 running within each host 121, provisioning VMs 131, migrating VMs 131 from one host 121 to another host 121, and load balancing between hosts 121. In one embodiment, the virtualization management system 118 can manage and integrate virtual computing resources provided by a third party cloud computing system with virtual computing resources of virtualization management system 118 to form a unified “hybrid” computing platform.

The virtualization management system 118 includes a resource management service 133, an upgrade management service 136, and/or other applications. The resource management service 133 can be executed to allocate workloads 139 (e.g., 139a . . . 139f) to one or more hosts 121 based on various factors. For example, the resource management service 133 can add an extra host 121 to the set of hosts 121 assigned to a workload 139 in response to an increase in demand for computing resources. As another example, the resource management service 133 can reassign VMs 131 within a workload 139 from one host 121 to another host 121 in order to more effectively use the hosts 121 assigned to the workload 139. For example, if a first host 121 is scheduled for an upgrade, the resource management service 133 can reassign VMs 131 executing on the first host 121 to a second host 121 based on various factors that can be used to identify the second host 121 as the best candidate host 121 among other hosts 121 in the data center. The resource management service 133 can include a number of modules and components that work in concert for management of the hosts 121 and workloads 139. For example, the resource management service 133 can include VSphere™ High Availability (HA), VMware Distributed Resource Scheduler (DRS), VMware VCenter™ Server, and other VMware VSphere™ components. The various components of the resource management service 133 can work in concert to achieve the functionalities described for the resource management service 133.

The upgrade management service 136 can manage the deployment, upgrades, and configuration of the systems associated with the operation of hosts computing clusters 106 within the virtualized computing environment 103 and the computing resources that make up the computing clusters 106. For example, a host upgrade can include an operation on the host 121 to update the image on the host 121. In various examples, some installations and update operations require the host 121 to be placed in a maintenance mode. When a host 121 is in maintenance mode all other activities are to be halted. For example, all VMs executing on a given host 121 will need to be evacuated in order for the host 121 to be upgraded. A data center administrator or cloud computing operator can interact with the upgrade management service 136 using a management console accessible by a client device 109 to schedule, initiate, and configure upgrades for software systems associated with the operation of the virtualized computing environment.

In various examples, the upgrade management service 136 can determine an upgrade sequence that defines an order in each the hosts 121 of a computing cluster 106 are to be upgraded to maximize efficiencies of the VMs 131 executing on each of the hosts 121. In particular, during a cluster upgraded, the order in which the hosts 121 are upgraded can have an impact on the workloads 139 and other long running operations occurring on the hosts 121. In various examples, in order to compute the optimal sequence in which the hosts 121 should be upgraded, the upgrade management service 136 determines an evacuation cost of each host 121. The evacuation cost corresponds to the cost associated with shutting down VMs 131 and other services executing on the hosts 121 and migrating the VMs 131 to other hosts 121. Various cost factors considered in determining the evacuation cost include: (1) the cost associated with updating the internal state of the host to prevent other operations from using the host 121; (2) the costs associated with re-registering powered-off VMs 131 on the host to another host 121 in the cluster 106; (3) the cost associated with migrating powered-on VMs 131 on the host 121 to other hosts 121 in the cluster; and (4) the cost associated with evacuation data storage objects from the host 121.

In various examples, the sequence is defined as a function of the evacuation costs and scheduling constraints for each host 121. The scheduling constraints can be based on evacuation policies defined by an administrator or other factors associated with a given host 121 or VM 131. For example, an administrator may configure evacuation policies for migrating workloads 139 within a computing cluster 106. For example, if a VM 131 is sensitive to migration, then it might be desirable to minimize the number of times that the VM 131 is migrated in the overall cluster upgrade. As such, the evacuation policy for the given VM 131 may identify the constraint that the VM 131 can only be moved a predefined number of times. In some examples, this predefined number can equal “1” indicating that the VM 131 can only be migrated once during the upgrade process. Similarly, certain workloads 139 or VMs 131 may require a specific time window for migration to occur so that administrators can prepare an automate necessary corrective actions when a migration is scheduled during a predefined time window. As such, the upgrade management service 136 can define the upgrade sequence for upgrading the hosts 121 according to the evacuation policies, evacuation costs for the hosts 121, and/or other types of constraints or factors.

The host data 127 can contain information about the hosts 121 that are managed by the virtualization management system 118. For example, the host data 127 can include information such as the amount of memory installed on the host 121, the number and type of processors installed on the host 121, the number and type of GPUs installed on the host 121, the number and type of network connections installed on the host 121, and various other data. The host data 127 can also include a record of the workload(s) 139 (e.g., specific VMs 131) performed by particular host(s) 121. In various examples, the host data 127 contains an upgrade status 157 for the given host 121. The upgrade status 157 indicates whether the host is in a maintenance mode (e.g., currently being upgraded), scheduled to be in a maintenance mode (e.g., upgrade pending), or already upgraded.

VM data 130 represents information about VMs 131 that are executed by hosts 121 within the virtualized computing environment 103. VM data 130 can include allocated CPU, memory, and storage resources for the various VMs, network configuration for the VMs, or an operating system image for the VMs. VM data 130 can also include certificate data, encryption data, security credentials, or other data needed to configure and operate VMs 166 within the virtualized computing environment 103.

The VM data can also include a maintenance cost efficiency 142. In various examples, the maintenance cost efficiency 142 relates to the efficiency of a performance loss associated with migrating the VM from the current host 121 to other hosts 121 in the computing cluster 106. In particular, the maintenance cost efficiency 142 is calculated based on a maintenance cost function and the demand required by the VM. In various example, the maintenance cost function is based on the upgrade sequence, the performance loss of migrating the VM 131 from the host 121, performance losses of the VM by migrating the VM from the current host 121 to the other hosts 121 in the computing cluster 106, and a migration probability that the VM will require subsequent migrations after being placed on a host 121 due to the host 121 requiring an upgrade. In various examples, the resource management service 133 considers the maintenance cost efficiency 142 as a factor, in addition to the efficiency values of other resources (e.g., CPU, memory, etc.), in selecting an optimal candidate host 121 for migrating a VM to when the host 121 that the VM is currently running on is placed in a maintenance mode for upgrade.

In various embodiments, the computing clusters 106 can include a plurality of devices installed in racks 115, which can make up a server bank, aggregate computing system, or a computer bank in a data center or other like facility. In some examples, the computing cluster can include a high-availability computing cluster. A high-availability computing cluster can include a group of computing devices that act as a single system and provides a continuous uptime for workloads. The devices in the computing clusters 106 can include any number of physical machines that perform workloads that include, virtual machines, virtual appliances, operating systems, drivers, hypervisors, scripts, and applications.

The devices in the racks 115 can include, for example, memory and storage devices, hosts 121a . . . 121t, switches 145a . . . 145d, and other devices. Hosts 121 can include graphics cards having one or more graphics processing units (GPUs) installed thereon, central processing units (CPUs), power supplies, and other components. The devices, such as hosts 121 and switches 145, can have dimensions suitable for quick installation in slots 148a . . . 148d on the racks 115. In various examples, the hosts 121 can include requisite physical hardware and software to create and manage a virtualization infrastructure. The physical hardware for a host 121 can include a CPU, graphics card (having one or more GPUs), data bus, memory, and other components. In some examples, the hosts 121 can include a pre-configured hyper-converged computing device where a hyper-converged computing device includes pre-tested, pre-configured, and pre-integrated storage, server and network components, including software, that are positioned in an enclosure installed in a slot 148 on a rack 115.

The various physical and virtual components of the computing clusters 106 can process workloads 139. Workloads 139 can represent virtual machines 131 or applications executed on the hosts 121. For example, in addition to a virtual machine 131, a workload can correspond to other objects running on the host 121 (e.g., group of containers (e.g., Kubernetes® pods), vSAN® objects, data transport connections, etc.) that need to be evacuated from the host 121 in preparation for the host upgrade. Workloads 139 can be executed on a host 121 that runs a hypervisor that facilitates access to the physical resources of the host device by workloads 139 running atop the hypervisor. In some examples, the hypervisor can be installed on a host 121 to support a virtual machine execution space wherein one or more virtual machines can be concurrently instantiated and executed. In some examples, the hypervisor can include the VMware ESX™ hypervisor, the VMware ESXi™ hypervisor, or similar hypervisor.

A host 121 can include an instance of a virtual machine 131. Each host 121 that acts as a host in the networked environment 100, and thereby includes one or more virtual machines 131, can also include a hypervisor. In some examples, the hypervisor can be installed on a host 232 to support a virtual machine execution space wherein one or more virtual machines 131 can be concurrently instantiated and executed. In some examples, the hypervisor can include the VMware ESX™ hypervisor, the VMware ESXi™ hypervisor, or similar hypervisor. It is understood that the computing clusters 106 are scalable, meaning that the computing clusters 106 in the networked environment 100 can be scaled dynamically to include additional hosts 121, switches 145, power sources, and other components, without degrading performance of the virtualization environment. Further, various physical and virtual components of the computing clusters 106 can process workloads 139. Workloads 139 can refer to the amount of processing that a host 121, switch 145, GPU, or other physical or virtual component has been instructed to process or route at a given time. The workloads 139 can be associated with VMs 131 or other software executing on the hosts 121.

The client device 109 can represent a computing device coupled to the network 112. The client device 109 can be a processor-based computer system. According to various examples, the client device 109 can be in the form of a desktop computer, a laptop computer, a personal digital assistant, a mobile phone, a smartphone, or a tablet computer system. The client device 109 can execute an operating system, such as Windows™, Android™, or iOS®, and has a network interface to communicate with the network 112.

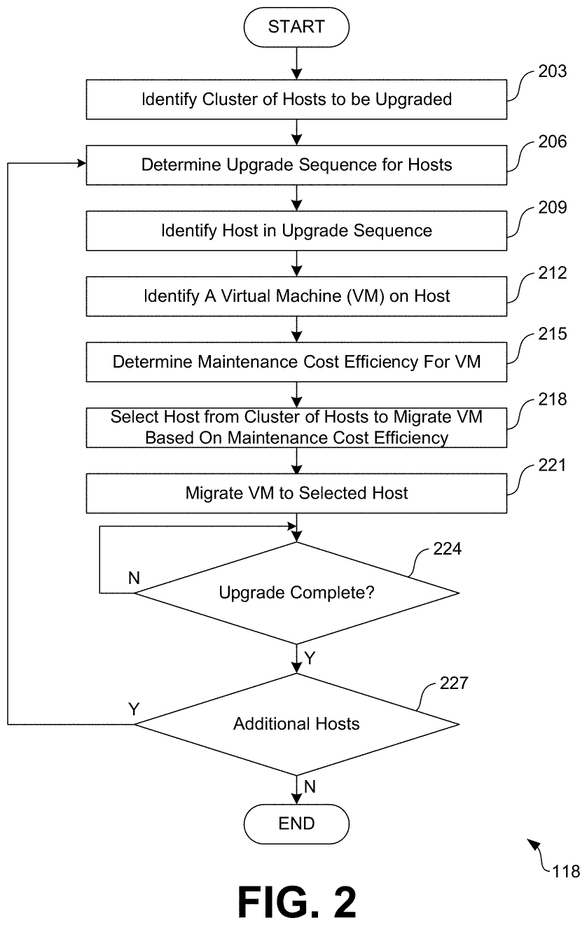

Turning now to FIG. 2, shown is a flowchart showing an example operation of how the virtualization management system 118 updates a cluster of hosts 121 according to a predefined upgrade sequence and considers the upgrade status 157 for each of the hosts 121 when determining an optimal host 121 for placement of evacuated VMs 131 (or other workloads 139) from the host 121 being upgraded according to various embodiments of the present disclosure. It should be noted that although the discussion of FIG. 2 is specific to VMs 131, the discussion is applicable to other types of workloads 139 that need to be migrated from a host 121 preparing to be upgraded.

At step 203, the virtualization management system 118 identifies a cluster of hosts 121 in a data center that require an upgrade. For example, the upgrade management service 136 of the virtualization management system 118 can obtain a request for an upgrade of a software-based system represented by the cluster of hosts 121 from an administrator or other cloud computing operator. The request can be obtained from a management console that is accessed by a user interacting with the client device 109. In some examples, the user can interact with the virtualization management system 118 using the management console to manage and build a virtualized cloud computing environment for an enterprise. Through interactions with virtualization management system 118, the administrator can be notified of upgrades that are available with respect to different software systems of the virtualized environment managed by virtualization management system 118. Using the management console, the administrator can then request an upgrade of a particular system or portion of the system, and the request is received by upgrade management service 136. The request can identify the cluster of hosts 121 associated with the system requiring the upgrade.

At step 206, the virtualization management system 118 determines an upgrade sequence for the hosts 121 requiring the upgrade. According to various examples, the upgrade sequence defines an order in each the hosts 121 of a computing cluster 106 are to be upgraded to maximize efficiencies of the VMs 131 executing on each of the hosts 121. The upgrade sequence can be determined as a function of evacuation costs and scheduling constraints for each host 121 in the cluster of hosts 121 requiring the upgrade. To begin, the upgrade management service 136 of the virtualization management system 118 determines the evacuation costs for each of the hosts 121 in the cluster of hosts 121 needing to be upgraded. When a host 121 is being upgraded, the host 121 can be placed in a maintenance mode status which is denoted by the upgrade status 157 of the particular host 121. Upon being placed in a maintenance mode, a variety of tasks occur on the host 121 in order to prepare the host 121 for the upgrade. For example, a host maintenance mode operation can involve the following tasks:
Pₕ: Updating the internal state of the host 121 to prevent other operations from using the host 121.
Rₕ: Re-registering powered-off VMs 131 on the host 121 to other hosts 121 in the computing cluster 106.
Mₕ: Migrating powered-on VMs 131 to other hosts 121 in the cluster 106.
Nₕ: Waiting until all active network transport connections terminate.
Vₕ: Evacuating virtual storage objects from the host 121

In various examples, the evacuation cost for a given host 121 corresponds to the amount of time it will take to prepare the host 121 for upgrade once the host 121 is place in a maintenance mode. Accordingly, the evacuation cost for each host 121 can be calculated as follows:

H_{evaccost}=(Pₕ+Rₕ+Mₕ+Nₕ+Vₕ) (1)

In addition to the evacuation costs, the upgrade management service 136 identifies the evacuation policies for each of the hosts 121. For example, an administrator may configure evacuation policies (e.g., constraints) for migrating workloads 139 (e.g., VMs 131 or other objects) within a computing cluster 106. For example, if a VM 131 is sensitive to migration, then it might be desirable to minimize the number of times that the VM 131 is migrated in the overall cluster upgrade. Similarly, certain workloads 139 or VMs 131 may require a specific time window for migration to occur so that administrators can prepare an automate necessary corrective actions when a migration is scheduled during a predefined time window. The upgrade management service 136 can determine the evacuation policies from the VM data 130 in the data store 124.

Upon determining the evacuation costs and evacuation policies for each of the hosts 121, the upgrade management service 136 can determine the upgrade sequence for upgrading the hosts. For example, the upgrade sequence can be determined according to Algorithm 1 and Algorithm 2.

Algorithm 1: Compute Upgrade Sequence

Input: List of Hosts
Output: Upgrade Sequence
1: N ← length (Hosts)
2: for all hosts h in Hosts do
3: h.evacCost ← GetEvacuationCost ( )
4: end for
5: sort (hosts, HostEvacCostSmall ( )) return hosts

Algorithm 2: HostEvacCostSmall

Input: host1, host 2, Map of EvacCost
Output: Returns true if host1 is less than (e.g., ordered before) host 2
1: MgmtVmsCnt1 ← NumOfMgmtVMsOnHost (host1)
2: MgmtVmsCnt2 ← NumOfMgmtVMsOnHost (host2)
3: if MgmtVmsCnt1 = MgmtVmsCnt2 then return
EvacCost[host1] ≤ EvacCost[host2]
4: else return MgmtVmsCnt1 < MgmtVmsCnt2
5: end if

At step 209, the virtualization management system 118 identifies a host 121 in the upgrade sequence. For example, the virtualization management system 118 can identify the host 121 based on the placement of the host 121 in the upgrade sequence. In various example, the hosts 121 is identified based on being the first or subsequent host 121 in the cluster of hosts 121 to be upgraded in accordance to the upgrade sequence. In various examples, the host 121 can be identified based on the upgrade status 157 of the host 121 and the upgrade sequence. For example, if the upgrade status 157 of the host 121 indicates that the host is in maintenance mode and the host 121 is the first host in the upgrade sequence, the virtualization management system 118 will identify the host 121 and begin preparing the host 121 for the upgrade.

At step 212, the virtualization management system 118 identifies a VM 131 executing on the host 121. The VM 131 can be identified based on an analysis of the host data 127 which indicates the VMs 131 executing and/or assigned to the hosts 121 at the current time.

At step 215, the virtualization management system 118 determines the maintenance cost efficiency 142 for the VM 131. The maintenance cost efficiency 142 relates to the efficiency of a performance loss associated with migrating the VM 131 from the current host 121 to other hosts 121 in the computing cluster 106. In particular, the maintenance cost efficiency 142 can be calculated based on a maintenance cost function and the CPU demand required by the VM 131. In various examples, the maintenance cost function is based on the upgrade sequence, the performance loss of migrating the VM 131 from the host 121, performance losses of the VM by migrating the VM from the current host 121 to the other hosts 121 in the computing cluster 106, and a migration probability that the VM 131 will require subsequent migrations after being placed on a host 121 due to the host 121 requiring an upgrade. For example, the maintenance cost efficiency 142 can be calculated as outlined below.

As discussed, when a host 121 is placed in maintenance mode, all VMs 131 running on the host 121 should be evacuated. However, there are multiple factors to consider when determining the impact associated with migrating a VM 131 from one host 121 to another host 121. To begin, a workload migration cost, WMC(VMᵢ, Hostⱼ), denotes a performance loss when VMᵢ running on Hostⱼ is migrated away from Hostⱼ, and the equation is given as:

$$WorkloadMigration Cost = \frac{{VM}_{i}^{′} sCPU Demand * constant * MigrationTimeEst}{Running Time of {VM}_{i} on {Host}_{j}} \qquad ( 2 )$$

In various examples, constant comprises a value corresponding to an estimate of the time to pause the execution of the VM 131 and allow the corresponding VM processes to complete. In some examples, constant=0.2. However, this value is not limited to 0.2, and can be a larger or a smaller value.

In various examples, the WorkloadMigration Cost for the VM 131 can be used to compute the maintenance cost for the VM 131. The maintenance cost, MC(VMᵢ, Hostᵢ, Hostⱼ), denotes performance loss when VMᵢ running on Hostᵢ is migrated to to-be-upgraded host Hostⱼ.

If Hostⱼ is already upgraded host then the maintenance cost should be zero (“0”), and the resource management service 133 can assume that there is no maintenance cost if VM 131 is evacuated to upgraded host 121. For migrating a VM 131 to a to-be upgraded host 121, the resource management service 133 considers any subsequent maintenance costs associated with the VM 131. For example, if VM running on Host is migrated to to-be-upgraded Hostⱼ then the chance that the VM is migrated from Hostⱼ to another to-be-upgraded host 121 when Hostⱼ is put into maintenance mode needs to be considered.

To formulate this condition, a probability function, P(VMᵢ, Hostⱼ, Hostₖ), is defined which corresponds to a probability that VMᵢ is migrated to target host Hostₖ when VMᵢ's current host Hostⱼ is put into maintenance mode. Given the workload migration cost and the conditional probability function, a maintenance cost function can be defined as follows:

MC(VMᵢ,Hostᵢ,Hostⱼ)=WMC(VMᵢ,Hostⱼ)+P(VMᵢ,Hostⱼ,Hostₖ)*MC(VMᵢ,Hostⱼ,Hostₖ)+ . . . +P(VMᵢ,Hostⱼ,Hostₘ)*MC(VMᵢ,Hostⱼ,Hostₘ) (3)

where Hostⱼ≤Host≤Hostₘ is to-be-upgraded host and they will be upgraded in alphabetical order. So, Hostⱼ is upgraded prior to Hostₖ and Hostₖ is upgraded prior to Hostₗ and so on. Thus, the maintenance cost of VMᵢ running on Hostᵢ against to-be-upgraded Hostⱼ is computed, and all subsequent maintenance costs are recursively computed after VMᵢ is migrated to Hostⱼ. To simplify the maintenance cost, all other factors except host compatibility can be ignored when computing the probability that VM 131 is migrated to to-be-upgraded host 121 when current host 121 is put into maintenance mode. As a result, the probability function can be expressed as

$$P ( {VM}_{i} , {Host}_{j} , {Host}_{k} ) = \frac{1}{Num . of Comptabile Hosts - 1} \qquad ( 4 )$$

Accordingly, the maintenance cost function can be simplified as

$$MC ( {VM}_{i} , {Host}_{i} , {Host}_{j} ) = WMC ( {VM}_{i} , {Host}_{j} ) + \frac{1}{Num . of Comptabile Hosts - 1} * MC ( VMi ; Hostj ; Hostk ) + … + \frac{1}{Num . of Comptabile Hosts - 1} * MC ( VMi ; Hostj ; Hostm ) \qquad ( 5 )$$

Thus, the efficiency of maintenance cost is given by

$$Eff ( Maintenance ) = \frac{demand - maintenancecost}{demand} \qquad ( 6 )$$

At step 218, the resource management service 133 of the virtualization management system 118 selects a host 121 from the cluster of hosts 121 to migrate the VM 131 to. In various examples, a host 121 can be selected based on a “goodness” of the host 121. The “goodness” of each of the hosts 121 can be determined based on a variety of factors associated with the host's resources and the resource requirements of the VM 131. For example, the host goodness can account for the cost of each resource type (e.g., CPU, memory, network costs) in addition to the maintenance costs associated with the VM 131 to determine the host goodness.

For example, each resource component, the cost can range from 0 to VM's CPU demand. So the efficiency of a resource component can be defined as:

$$Eff ( Resouce ) = \frac{demand - cost}{demand} \qquad ( 7 )$$

The total efficiency can be obtained by multiplying the efficiencies of all the components, including the maintenance cost efficiency 142.

TotalEff=Eff(cpu)×Eff(memory)×Eff(maint)× . . . . (8)

Finally host goodness is defined as:

HostGoodness=demand×TotalEff (9)

In various examples, the resource management service 133 determines a host goodness for each of the hosts 121 and selects the host 121 having the best host goodness value. For example, the resource management service 133 can rank the hosts 121 based on the host goodness value and select the highest ranked host 121.

In some examples, the resource management service 133 may determine that there are no optimal or available hosts 121 in the cluster of hosts 121 to migrate the VM 131 to when the current host 121 undergoes an upgrade. In this example, the virtualization management system 118 may instantiate a spillover host 121 to account for the needs of the VM 131. As such, the selected host 121 can correspond to the spillover hosts 121 when there are no available hosts 121 within the computing cluster 106 that can accept the VM 131.

At step 221, the virtualization management system 118 migrates the VM 131 to the selected host 121 from the current host 121.

At step 224, the virtualization management system 118 determines whether the upgrade of the current host 121 is complete. In particular, the virtualization management system 118 can determine if the upgrade status 157 indicates that the host 121 is in maintenance mode or if the maintenance mode status has been removed, thereby indicating a completion of the upgrade. If the upgrade is not complete, the virtualization management system 118 waits for the upgrade to be completed. Otherwise, the virtualization management system 118 proceeds to step 227.

At step 227, the virtualization management system 118 determines if there are additional hosts 121 to be upgraded. If there are additional hosts 121 to be upgraded, the virtualization management system 118 returns to step 206 to dynamically update the upgrade sequences of hosts 121 requiring an update. Otherwise, the process proceeds to completion.

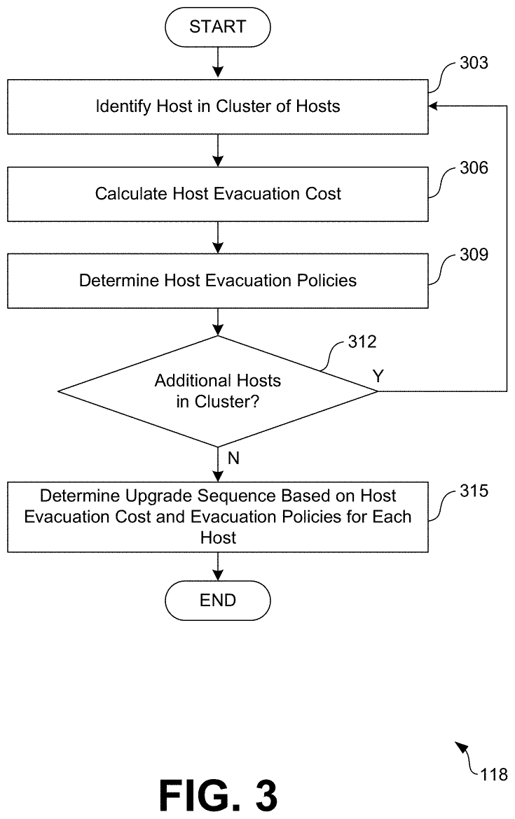

Referring to FIG. 3, shown is a flowchart showing an example operation of how the upgrade sequence is determined according to various embodiments. At step 303, the virtualization management system 118 identifies a host 121 in the cluster of hosts 121 associated with an upgrade. For example, the virtualization management system 118 can obtain a request for an upgrade of a software-based system represented by the cluster of hosts 121 from an administrator or other cloud computing operator. The request can identify the cluster of hosts 121 associated with the system requiring the upgrade. In some examples, the virtualization management system 118 can select the host 121 from the cluster of hosts 121 randomly. In other examples, the virtualization management system 118 can select the host 121 from the cluster of hosts based on a host identifier.

At step 306, the virtualization management system 118 calculates a host evacuation cost for the host 121. The evacuation cost corresponds to the cost associated with shutting down VMs and other services executing on the hosts 121 and migrating the VMs 131 (or other workloads 139) to other hosts 121. Various cost factors considered in determining the evacuation cost include: (1) the cost associated with updating the internal state of the host to prevent other operations from using the host 121; (2) the costs associated with re-registering powered-off VMs on the host to another host 121 in the cluster 106; (3) the cost associated with migrating powered-on VMs on the host 121 to other hosts 121 in the cluster; and (4) the cost associated with evacuation data storage objects from the host 121. Accordingly, the virtualization management system 118 determines the costs associated with each factor, and calculations the host evacuation costs based on a sum of the cost factors as illustrated by Equation (1).

At step 309, the virtualization management system 118 identifies the evacuation policies for the host 121. For example, the evacuation policies correspond to administrator-defined policies that are assigned to the hosts 121 with respect to migration of VMs 131 (or other workloads 139) between hosts 121. The virtualization management system 118 can access the evacuation policies from the VM data 130 in the data store 124.

At step 312, the virtualization management system 118 determines if there are additional hosts 121 in the cluster of hosts 121. For example, a system upgrade can apply to a cluster of hosts 121. Therefore, if there are additional hosts 121 that require an upgrade as part of the system upgrade that have not yet been evaluated, the virtualization management system 118 will determine that there are additional hosts 121 and proceed back to step 303. Otherwise, the virtualization management system 118 proceeds to step 315.

At step 315, the virtualization management system 118 determines the upgrade sequence for the cluster of hosts based on the host evacuation cost and evacuation policies for each host 121 in the cluster of hosts. As discussed in step 206 of FIG. 2, the upgrade sequence can be determined based on Algorithm 1 which accounts for the host evacuation cost and evacuation policies for each of the hosts in identifying an optimal upgrade sequence for upgrading the hosts 121. Thereafter, this process proceeds to completion.

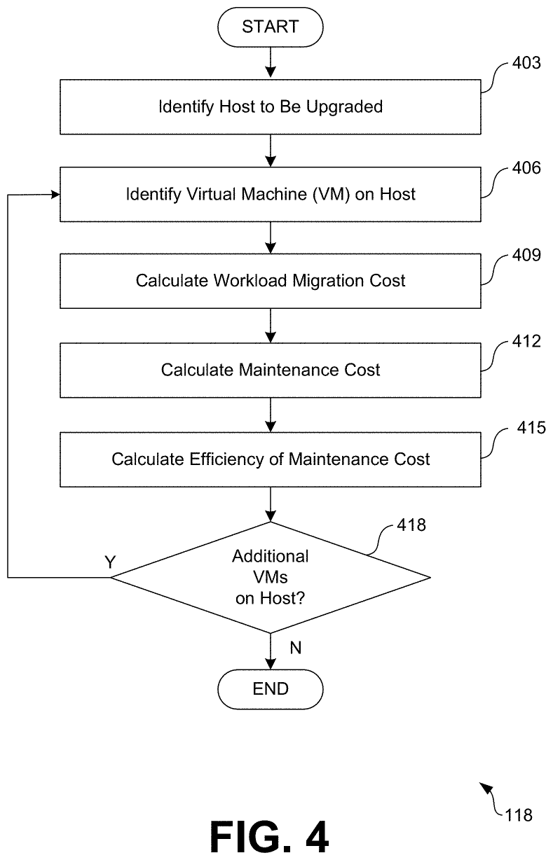

Referring to FIG. 4, shown is a flowchart showing an example operation of how the maintenance cost efficiency 142 for a VM 131 (or other type of workload 139) is determined according to various embodiments. It should be noted that although the discussion of FIG. 4 is specific to VMs 131, the discussion is applicable to other types of workloads 139 that need to be migrated from a host 121 preparing to be upgraded.

At step 403, the virtualization management system 118 identifies a host 121 to be upgraded. For example, the host 121 can be identified according to a change in upgrade status 157. In addition, the host 121 can be identified according to the upgrade sequence defined as a function of host evacuation costs and host evacuation policies.

At step 406, the virtualization management system 118 identifies a VM 131 executing on the host 121. The VM 131 can be identified based on an analysis of the host data 127 which indicates the VMs 131 executing and/or assigned to the hosts 121 at the current time.

At step 409, the virtualization management system 118 calculates the workload migration cost associated with the VM. The workload migration cost, as defined by Equation (2), denotes a performance loss when VMᵢ running on Hostⱼ is migrated away from Hostⱼ.

At step 412, the virtualization management system 118 calculates the maintenance cost for the VM 131. The maintenance cost, MC(VMᵢ, Hostᵢ, Hostⱼ), denotes performance loss when VMᵢ running on Hostᵢ is migrated to to-be-upgraded host Hostⱼ. If Hostⱼ is already upgraded host then the maintenance cost should be zero (“0”). However, for migrating a VM 131 to a to-be upgraded host 121, the resource management service 133 considers any subsequent maintenance costs associated with the VM 131. Accordingly, to calculate the maintenance cost for the VM 131, the probability function, P(VMᵢ, Hostⱼ, Hostₖ), is defined which corresponds to a probability that VMᵢ is migrated to target host Hostₖ when VMᵢ's current host Hostⱼ is put into maintenance mode. Accordingly, as defined by Equations (3) and (4), the maintenance cost function for the VM 131 is calculated according to the probability function, the maintenance cost for a given host 121, and the workload migration cost.

At step 415, the maintenance cost efficiency 142 for the VM 131 is calculated. The maintenance cost efficiency 142 relates to the efficiency of a performance loss associated with migrating the VM 131 from the current host 121 to other hosts 121 in the computing cluster 106. In particular, the maintenance cost efficiency 142 can be calculated based on a maintenance cost function and the CPU demand required by the VM 131. According to various examples, the maintenance cost efficiency 142 is calculated based on Equation (6).

At step 418, the virtualization management system 118 determines if there are additional VMs 131 on the host 121 that need to be evacuated. If there are additional VMs 131 requiring evacuation, the virtualization management system 118 returns to step 406. Otherwise, this portion of the process proceeds to completion.

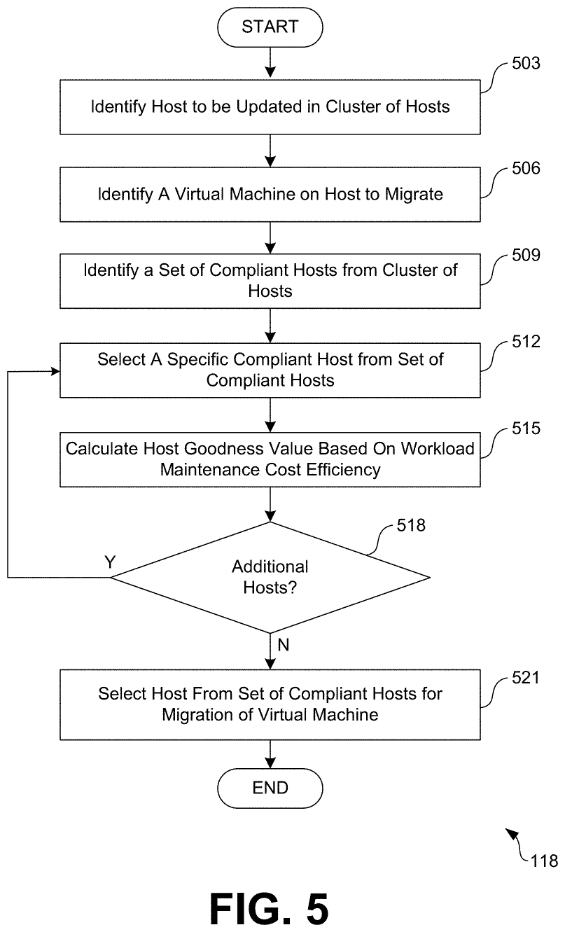

Referring to FIG. 5, shown is a flowchart showing an example operation of how the virtualization management system 118 considers the maintenance costs associated with VMs 131 (or other types of workloads 139) as a factor for host placement of VMs according to various embodiments. It should be noted that although the discussion of FIG. 5 is specific to VMs 131, the discussion is applicable to other types of workloads 139 that need to be migrated from a host 121 preparing to be upgraded.

At step 503, the virtualization management system 118 identifies a host 121 in the cluster of hosts 121 to be updated. For example, the virtualization management system 118 can identify the host 121 based on the placement of the host 121 in the upgrade sequence. In various example, the hosts 121 is identified based on being the first or subsequent host 121 in the cluster of hosts 121 to be upgraded in accordance to the upgrade sequence. In various examples, the host 121 can be identified based on the upgrade status 157 of the host 121 and the upgrade sequence. For example, if the upgrade status 157 of the host 121 indicates that the host is in maintenance mode and the host 121 is the next host in the upgrade sequence, the virtualization management system 118 will identify the host 121 and begin preparing the host 121 for the upgrade.

At step 506, the virtualization management system 118 identifies a VM 131 executing on the host 121 to migrate to another host 121. The VM 131 can be identified based on an analysis of the host data 127 which indicates the VMs 131 executing and/or assigned to the hosts 121.

At step 509, the virtualization management system 118, via the resource management service 133, identifies a set of compliant hosts 121 from the cluster of hosts 121 that can be considered as candidate hosts 121 for the VM 131. In particular, the host data 127 can indicate administrator-defined policies assigned to the hosts 121 and the VM 131. For example, the host data 127 may identify the types of VMs 131 that can be executed and/or supported by the given host 121. In particular, the candidate hosts 121 should be compatible with respect to the policies associated with the VM 131. As such, the set of compliant hosts 121 are selected from the cluster of hosts 121 based on the compliance policies associated with the VM 131 being compatible with the host 121.

At step 512, the virtualization management system 118 via the resource management service 133 selects a specific compliant host 121 from the set of compliant hosts 121. In some examples, the compliant host 121 can be selected randomly. In other examples, the compliant host 121 can be selected according to the upgrade sequence. In other examples, the compliant host 121 can be selected according to a host identifier.

At step 515, the virtualization management system 118 via the resource management service 133 calculates a host goodness for the host 121 with respect to migrating the VM 131 to the specific host 121. The host goodness for the host 121 can be determined based on a variety of factors associated with the host resources and the resource requirements of the VM 131. For example, the host goodness can consider the efficiency of the cost of each resource type (e.g., CPU, memory, network costs) in addition to the maintenance cost associated with the VM 131 to determine the host goodness. Equation (7) defines an example for calculating the efficiency of the resource costs for each resource. The total efficiency associated with the VM 131 can be obtained by multiplying the efficiencies of all the components, including the maintenance cost efficiency 142, as defined by Equation (9). Finally, host goodness for the host 121 is defined by Equation (9) and corresponds the product of the total resource efficiency associated with the VM 131 and the host demand.

At step 518, the virtualization management system 118 determines if there are additional hosts 121. If there are additional hosts 121, the virtualization management system 118 returns to step 512. Otherwise, the virtualization management system 118 proceeds to step 521.

At step 521, the virtualization management system 118 selects a host 121 from the set of compliant hosts 121 for migration of the VM. The host 121 is selected according to the value of the host goodness associated with the host. For example, the resource management service 133 of the virtualization management system 118 can rank the hosts 121 based on the host goodness value and select the highest ranked host 121. Thereafter, this portion of the process proceeds to completion.

Functionality attributed to the virtualization management system 118, resource management service 133, and upgrade management service 136 can be implemented in a single process or application or in multiple processes or applications. The separation or segmentation of functionality as discussed herein is presented for illustrative purposes only.

The flowcharts of FIGS. 3-5 show examples of the functionality and operation of implementations of components described herein. The components described herein can be embodied in hardware, software, or a combination of hardware and software. If embodied in software, each element can represent a module of code or a portion of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts and sequence diagram show a specific order of execution, it is understood that the order of execution can differ from that which is shown. For example, the order of execution of two or more elements can be switched relative to the order shown. Also, two or more elements shown in succession can be executed concurrently or with partial concurrence. Further, in some examples, one or more of the elements shown in the flowcharts can be skipped or omitted.

The computing environment 103, computing clusters 106, the client devices 109 or other components described herein can include at least one processing circuit. Such a processing circuit can include, for example, one or more processors and one or more storage devices that are coupled to a local interface. The local interface can include, for example, a data bus with an accompanying address/control bus or any other suitable bus structure.

The one or more storage devices for a processing circuit can store data or components that are executable by the one or more processors of the processing circuit. For example, the virtualization management system 118, the resource management service 133, the upgrade management service 136 and/or other components can be stored in one or more storage devices and be executable by one or more processors. Also, a data store can be stored in the one or more storage devices.

The virtualization management system 118, the resource management service 133, the upgrade management service 136 and/or other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more of the components described herein that include software or program instructions can be embodied in any non-transitory computer-readable medium for use by or in connection with an instruction execution system such as a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in at least one computing device or by using multiple computing devices.

As used herein, “about,” “approximately,” and the like, when used in connection with a numerical variable, can generally refers to the value of the variable and to all values of the variable that are within the experimental error (e.g., within the 95% confidence interval for the mean) or within +/−10% of the indicated value, whichever is greater.

Where a range of values is provided, it is understood that each intervening value and intervening range of values, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All such modifications and variations are intended to be included herein within the scope of this disclosure.

Therefore, the following is claimed:

1. A system for upgrade-awareness resource scheduling, comprising:
at least one computing device; and
program instructions executable in the at least one computing device that, when executed by the at least one computing device, cause the at least one computing device to:
determine that a cluster of hosts require an upgrade;
determine an upgrade sequence for upgrading the cluster of hosts;
identify a first host of the cluster of hosts based on the upgrade sequence;
calculate a maintenance cost associated with a workload running on the first host based on the upgrade sequence; and
select a second host of the cluster of hosts to migrate the workload running on the first host to based on the maintenance cost.

2. The system of claim 1, wherein, when executed, the program instructions further cause the at least one computing device to at least calculate an evacuation cost for each host in the cluster of hosts, the evacuation cost corresponding an amount of time to prepare a respective host for the upgrade and evacuate one or more workloads running on the respective host, the upgrade sequence being determined based on the evacuation cost for each host.

3. The system of claim 1, wherein, when executed, the program instructions further cause the at least one computing device to at least determine a set of evacuation policies for each host in the cluster of hosts, the upgrade sequence further being determined based on the set of evacuation policies for each host.

4. The system of claim 3, wherein the set of evacuation policies are defined by an administrator of an enterprise.

5. The system of claim 1, wherein, when executed, the program instructions cause the at least one computing device to at least calculate a workload migration cost for the workload, the workload migration cost corresponding to a performance loss for migrating the workload away from the first host, the maintenance cost being calculated based on the workload migration cost.

6. The system of claim 1, wherein the maintenance cost is based on a respective performance loss associated with migrating the workload to each host of the cluster of hosts.

7. The system of claim 1, wherein selecting the second host of the cluster of hosts to migrate the workload from the first host to the second host is further based on a central processing unit (CPU) cost of the workload and a memory cost of the workload.

8. A method for upgrade-awareness resource scheduling, comprising:
determining, by at least one computing device, that a cluster of hosts require an upgrade;
determining, by the at least one computing device, an upgrade sequence for upgrading the cluster of hosts;
identifying, by the at least one computing device, a first host of the cluster of hosts based on the upgrade sequence;
calculating, by the at least one computing device, a maintenance cost associated with a workload running on the first host based on the upgrade sequence; and
selecting, by the at least one computing device, a second host of the cluster of hosts to migrate the workload running on the first host to based on the maintenance cost.

9. The method of claim 8, further comprising calculating an evacuation cost for each host in the cluster of hosts, the evacuation cost corresponding an amount of time to prepare a respective host for the upgrade and evacuate one or more workloads running on the respective host, the upgrade sequence being determined based on the evacuation cost for each host.

10. The method of claim 8, further comprising determining a set of evacuation policies for each host in the cluster of hosts, the upgrade sequence further being determined based on the set of evacuation policies for each host.

11. The method of claim 10, wherein the set of evacuation policies are defined by an administrator of an enterprise.

12. The method of claim 8, further comprising calculating a workload migration cost for the workload, the workload migration cost corresponding to a performance loss for migrating the workload away from the first host, the maintenance cost being calculated based on the workload migration cost.

13. The method of claim 8, wherein the maintenance cost is based on a respective performance loss associated with migrating the workload to each host of the cluster of hosts.

14. The method of claim 8, wherein selecting the second host of the cluster of hosts to migrate the workload from the first host to the second host is further based on a central processing unit (CPU) cost of the workload and a memory cost of the workload.

15. A non-transitory computer readable storage medium embodying executable instructions which, when executed by a processor, cause a computing device to at least:
determine that a cluster of hosts require an upgrade;
determine an upgrade sequence for upgrading the cluster of hosts;
identify a first host of the cluster of hosts based on the upgrade sequence;
calculate a maintenance cost associated with a workload running on the first host based on the upgrade sequence; and
select a second host of the cluster of hosts to migrate the workload running on the first host to based on the maintenance cost.

16. The non-transitory computer readable storage medium of claim 15, wherein, when executed, the executable instructions cause the processor to calculate an evacuation cost for each host in the cluster of hosts, the evacuation cost corresponding an amount of time to prepare a respective host for the upgrade and evacuate one or more workloads running on the respective host, the upgrade sequence being determined based on the evacuation cost for each host.

17. The non-transitory computer readable storage medium of claim 15, wherein, when executed, the executable instructions cause the processor to determine a set of evacuation policies for each host in the cluster of hosts, the upgrade sequence further being determined based on the set of evacuation policies for each host.

18. The non-transitory computer readable storage medium of claim 15, wherein, when executed, the executable instructions cause the processor to calculate a workload migration cost for the workload, the workload migration cost corresponding to a performance loss for migrating the workload away from the first host, the maintenance cost being calculated based on the workload migration cost.

19. The non-transitory computer readable storage medium of claim 15, wherein the maintenance cost is based on a respective performance loss associated with migrating the workload to each host of the cluster of hosts.

20. The non-transitory computer readable storage medium of claim 15, wherein selecting the second host of the cluster of hosts to migrate the workload from the first host to the second host is further based on a central processing unit (CPU) cost of the workload and a memory cost of the workload.
